(19) United States
(12) Patent Application Publication
(10) Pub. No.: US 2025/0156147 A1
(43) Pub. Date: May 15, 2025

(54) FLOATING POINT DIVISION USING VARIABLE LENGTH INTEGER DIVISION

(71) Applicant: SKYWORKS SOLUTIONS, INC., Irvine, CA (US)

(72) Inventor: Mikael Mortensen, Milpitas, CA (US)

(21) Appl. No.: 18/937,314

(22) Filed: Nov. 5, 2024

Related U.S. Application Data
(60) Provisional application No. 63/599,156, filed on Nov. 15, 2023.

(51) Int. Cl. G06F 7/499; G06F 7/535

(52) U.S. Cl. CPC G06F 7/49915; G06F 7/535

(57) ABSTRACT

A division circuit including a first normalizer configured to shift a first input to a first higher power; a second normalizer configured to shift a second input to a second higher power; a subtraction circuit configured to iteratively subtract the second input from the first input for a number of iterations to produce a result, the number of iterations based on a number of shifts of the first input; a first output configured to provide the result; and a second output configured to provide the number of iterations.

### CROSS-REFERENCE TO RELATED APPLICATIONS

This reference claims priority under 35 U.S.C. § 119 (e) to U.S. Provisional Patent Application 63/599,156, titled FLOATING POINT DIVISION USING VARIABLE LENGTH INTEGER DIVISION, filed on Nov. 15, 2023, and hereby incorporated by reference in its entirety for all purposes.

### BACKGROUND

### 1. Field of the Disclosure

At least one example in accordance with the present disclosure relates generally to division circuits for use in computers and other circuits.

### 2. Discussion of Related Art

In modern processors, division circuits may be replaced with multiplication circuits that transform division problems into multiplication problems, or may execute division algorithms of indeterminate length. During division the processor cannot use the core (or other portion of the circuit, as may be the case for single core processors or some multicore processors) that is carrying out the division because there is no way to predict when the division will be complete.

### SUMMARY

According to at least one aspect of the present disclosure, a division circuit is provided, the division circuit comprising a first normalizer configured to shift a first input to a first higher power; a second normalizer configured to shift a second input to a second higher power; a subtraction circuit configured to iteratively subtract the second input from the first input for a number of iterations to produce a result, the number of iterations based on a number of shifts of the first input; a first output configured to provide the result; and a second output configured to provide the number of iterations.

In some examples, the first higher power and the second higher power are the same higher power. In some examples, the first higher power and the second higher power are different higher powers. In some examples, the division circuit further comprises a denormalizer configured to shift the result to a lower power based on a difference between the number of shifts of the first input and a number of shifts of the second input. In some examples, the number of iterations is further determined based on a difference between a width of the first input and the number of shifts of the first input. In some examples, the number of shifts of the first input equals the number of shifts of the first input by the first normalizer to the first higher power. In some examples, the number of iterations is further determined based on a difference of the number of shifts of the first input and a number of shifts of the second input.

According to at least one aspect of the present disclosure, a computer system is presented, the computer system comprising a division circuit; and at least one controller, the at least one controller configured to: provide an instruction to the division circuit to perform a division; receive, from the division circuit, a number of iterations; execute one or more operations for the number of iterations; and receive a result of the division.

In some examples, the division circuit includes: a first normalizer configured to shift a first input to a first higher power; a second normalizer configured to shift a second input to a second higher power; a subtraction circuit configured to iteratively subtract the second input from the first input for a number of iterations to produce a result, the number of iterations based on a number of shifts of the first input; a first output configured to provide the result; and a second output configured to provide the number of iterations. In some examples, the division circuit includes: a denormalizer configured to shift the result to a lower power based on a difference between the number of shifts of the first input and a number of shifts of the second input. In some examples, the number of iterations is further determined based on a difference between a width of the first input and the number of shifts of the first input. In some examples, the number of shifts of the first input equals the number of shifts of the first input by the first normalizer to the first higher power. In some examples, the number of iterations is further determined based on a difference of the number of shifts of the first input and a number of shifts of the second input. In some examples, the first normalizer shifts the first input to the first higher power until a non-zero value of the first input is present at a highest power bit of the first input. In some examples, the second normalizer shifts the second input to the second higher power until a non-zero value of the second input is present at a highest power bit of the second input. In some examples, the computer system further comprises a communication port configured to be coupled to at least one additional controller and further configured to send and receive data from the at least one additional controller. In some examples, the at least one controller is configured to receive instructions from the at least one additional controller and to execute those instructions for a number of clock cycles following providing the instruction to the division circuit to perform the division less than or equal to the number of iterations. In some examples, the at least one controller is configured to sequentially execute the one or more operations for a number of clock cycles equal to the number of iterations and beginning on a clock cycle following a first clock cycle on which the at least one controller provided the instruction to the division circuit. In some examples, the one or more operations are unrelated to the division. In some examples, the number of iterations corresponds to a minimum number of clock cycles to complete the division.

According to at least one aspect of the present disclosure, a method for efficiently utilizing computational resources is presented, the method comprising: determining a minimum number of clock cycles required to complete a division operation using a division circuit; sequentially performing operations following a beginning of the division operation using computational resources other than the division circuit for a number of clock cycles equal to or greater than the minimum number of clock cycles.

In some examples, determining the minimum number of clock cycles includes: receiving a dividend; receiving a divisor; shifting the dividend to a first higher power; shifting the divisor to a second higher power; and determining a length of the dividend. In some examples, determining the minimum number of clock cycles further includes: determining a difference between the length and a number of shifts of the dividend to the first higher power. In some examples, determining the minimum number of clock cycles further includes: determining a difference between a number of shifts of the dividend to the first higher power and a number of shifts of the divisor to the second higher power. In some examples, the first higher power and the second higher power are a same higher power.

According to at least one aspect of the present disclosure, a division circuit is presented, comprising a first normalizer configured to shift a first input to a first higher power; a second normalizer configured to shift a second input to a second higher power; a subtraction circuit configured to iteratively subtract the second input from the first input for a number of iterations to produce a result, the number of iterations based on a number of shifts of the first input; a first output configured to provide the result; and a second output configured to provide the number of iterations.

In some examples, the division circuit further comprises a first summing node, and a second summing node, the first summing node coupled between the first normalizer and the subtraction circuit and the second summing node coupled between the first normalizer and the second normalizer. In some examples, the first summing node is configured to provide to the subtraction circuit a difference based on a width of the first input and the number of shifts of the first input. In some examples, the division circuit further comprises a denormalizer. In some examples, the second summing node is configured to provide a difference of the number of shifts of the first input and a number of shifts of the second input to the denormalizer. In some examples, the denormalizer is configured to shift the result to a lower power, a number of shifts of the result to the lower power based on the difference of the number of shifts of the first input and the number of shifts of the second input. In some examples, the division circuit further comprises a first summing node coupled between the first normalizer, the second normalizer, and a second summing node, the second summing node being further coupled to the subtraction circuit. In some examples, the first summing node is configured to determine a difference based on the number of shifts of the first input and a number of shifts of the second input, and to provide the difference to the second summing node. In some examples, the second summing node is configured to determine a sum of the difference and a constant value, and to provide the sum to the subtraction circuit. In some examples, the number iterations is based on the sum.

According to at least one aspect of the present disclosure, a computer system is presented, comprising: a division circuit; and at least one controller, the at least one controller configured to: provide an instruction to the division circuit to perform a division; receive, from the division circuit, a number of iterations corresponding to a number of clock cycles that the division will take to perform; execute one or more operations for the number of clock cycles while the division is being performed by the division circuit; and receive a result of the division.

In some examples, division circuit includes a first normalizer configured to shift a first input to a first higher power; a second normalizer configured to shift a second input to a second higher power; a subtraction circuit configured to iteratively subtract the second input from the first input for a number of iterations to produce a result, the number of iterations based on a number of shifts of the first input; a first output configured to provide the result; and a second output configured to provide the number of iterations to at least the controller. In some examples, the division circuit includes a denormalizer configured to shift the result to a lower power based on a difference between the number of shifts of the first input and a number of shifts of the second input. In some examples, the number of iterations is further determined based on a difference between a width of the first input and the number of shifts of the first input, wherein the number of shifts of the first input equals the number of shifts of the first input by the first normalizer to the first higher power. In some examples, the number of iterations is further determined based on a difference of the number of shifts of the first input and a number of shifts of the second input. In some examples, the computer system further comprises at least one additional controller, the at least one additional controller being configured to receive instructions from the controller and to execute those instructions for the number of clock cycles. In some examples, the one or more operations are unrelated to the division.

According to at least one aspect of the present invention, a method for efficiently utilizing computational resources is provided, the method comprising sequentially performing operations following a beginning of a division operation using computational resources other than the division circuit for a number of clock cycles equal to or greater than a minimum number of clock cycles, wherein the minimum number of clock cycles is determined by shifting a first input to a first higher power by a first number of shifts and modifying the first number of shifts by a second value to produce a number of iterations corresponding to the minimum number of clock cycles.

In some examples, the second value is a width of the first input, and the number of iterations is determined based on a difference between the first number of shifts and the second value. In some examples, the second value is a second number of shifts, the second number of shifts being a number of shifts of a second input, and the number of iterations is determined based on a difference between the first number of shifts and a second number of shifts.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a division circuit according to an example;

FIG. 2 illustrates a division circuit according to an example;

FIG. 3 illustrates a circuit architecture according to an example; and

FIG. 4 illustrates a process for utilizing resources during a division operation according to an example.

### DETAILED DESCRIPTION

In a given computer system, division may take an indeterminate amount of time to complete. For example, the operation A=B (which may also be written as A/B or

$$\frac{A}{B} )$$

may take less than one clock cycle, one clock cycle, or more than one clock cycle to complete, but the total number of clock cycles the division will take may not be knowable before the division itself is actually completed. Such systems are called nondeterministic systems because it is not possible to know how many clock cycles or how much time will be required to complete an operation prior to actually completing the operation. This is particularly notable when performing floating point division. Even relatively fast floating point division algorithms (e.g., those using Newton-Raphson's method, and so forth) are nondeterministic.

As a result, the instruction stack for the computer system (or for a given processor, core, or other subcomponent of the computer system) may need to idle (that is, to wait) for the division to be completed before performing other instructions such as those unrelated to the division or dependent upon the division.

Systems and methods provided herein disclose a deterministic method of performing floating point division. These systems and methods allow the computer system to know exactly how long it will take to complete a division operation having the necessary accuracy (in terms of significant bits) prior to completing the division. As a result, while the division circuit calculates, the computer system need not idle and may instead execute other instructions. In some examples, the computer system may be able to multi- or hyper-thread operations, threads, and/or processes while the division circuit is calculating.

As a simple example, suppose a computer system has two processor cores along with the division circuit disclosed herein. The computer system may execute a first thread (e.g. a first set of instructions and/or operations) on the first core and a second thread on the second core. When the second thread calls for division, the computer system may know exactly how many clock cycles will be required to complete the division and will know at least the minimum number of clock cycles required to complete the division. The computer system can let the division circuit calculate while the second core's other resources are devoted to other operations. For example, the second core's other resources may be used to assist in operations related to the first thread being executed on the first core, or to an entirely new thread, a different process, and so forth.

The second core may resume the second thread as soon as the division is completed. In this way, the computer system can utilize all or a substantial portion of its available processing resources without idling during division.

In some examples, various division circuits disclosed herein may receive a dividend (called “A” herein) and a divisor (called “B” herein). The division circuit may normalize A and B by shifting the bits of A and B to higher power positions until a “1” occupies the highest power position (e.g., until a “1” occupies the most significant bit (MSB) or the “leftmost” position, using the convention that the leftmost bit is the most significant bit). The division circuit may determine the number of shifts required for a “1” to occupy the MSB for each of A and B. Based on the number of shifts, the division circuit can determine precisely how many iterations, or at least a minimum number of iterations, of a subtraction are required to determine the result of the division to the desired level of accuracy, thus allowing the computer system to know how long it will take for the division to be completed. Once the division is completed, the division circuit may provide the result to the computer system for use.

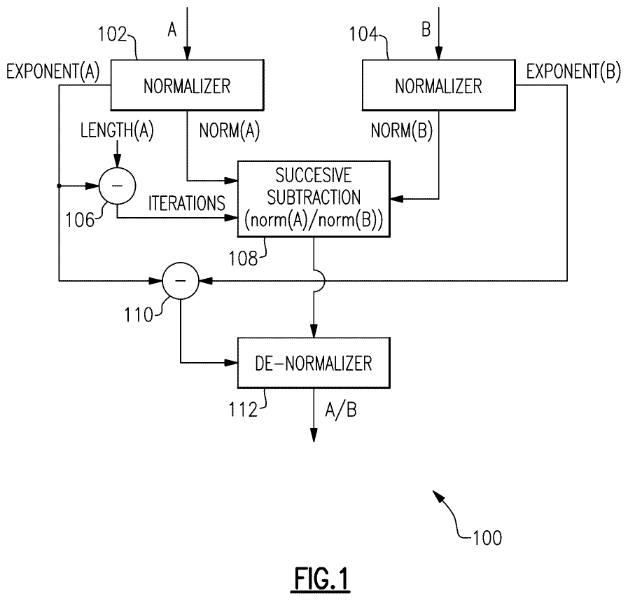

FIG. 1 illustrates a division circuit 100 according to an example. The division circuit 100 may determine the number of clock cycles requires to complete the calculation of a division. The division circuit 100 includes a first normalizer 102, a second normalizer 104, a first summing node 106, a subtraction block 108, a second summing node 110, and a de-normalizer 112. The summing nodes do not necessarily only perform addition in the sense of addition of positive numbers. The summing nodes may perform subtraction (i.e., the addition or summing of at least one negative number) as well.

The first normalizer 102 is coupled to the subtraction block 108 at a first connection and to the first summing node 106 and second summing node 110 at a second connection. The second normalizer 104 is coupled to the subtraction block 108 at a first connection and to the second summing node 110 at a second connection. The first summing node 106 is coupled to the first normalizer 102 and second summing node 110 at a first connection and to the subtraction block 108 at a second connection. The second summing node 110 is coupled to the first normalizer 102 and first summing node 106 at a first connection, the second normalizer 104 at a second connection, and the de-normalizer 112 at a third connection. The subtraction block 108 is coupled to the first normalizer 102 at a first connection, the second normalizer 104 at a second connection, the first summing node 106 at a third connection, and the de-normalizer 112 at a fourth connection.

The first normalizer 102 receives a dividend (“A”) from an input and normalizes the dividend. The dividend may be a sequence of bits, with some bits having greater significance (e.g., being tied to a higher power). The first normalizer 102 may shift the bits of the dividend to increasing powers until a non-zero value is present at the MSB. This process of shifting the bits of the dividend may be called the normalization process. The first normalizer 102 may track or otherwise determine the number of shifts needed to accomplish the normalization process. The first normalizer 102 may then provide the normalized dividend to the subtraction block 108, and may provide the number of shifts, possibly modified by the exponent if the dividend is a floating point number, to the first summing node 106 and second summing node 110. The number of shifts of the dividend, modified or unmodified by the exponent of the floating point if the dividend is a floating point, will be referred to as exponent A or EXP (A).

To make the normalization process more concrete, consider the following example. Assuming the left-most bit is the MSB, the sequence b0110 (the “b” proceeding the bits indicates that the sequence is a binary encoded sequence of bits) can be read, from left-to-right, as equivalent to: 0·2³+1·2²+1·2¹+0·2⁰. Note that the left-most bit is the highest power bit because it is multiplied by 2³, where “3” is the highest exponent. To normalize the sequence b0110 requires one shift in the direction of the highest power bit to produce b1100 (which is equivalent to 1·2³+1·2²+0·2¹+0·2⁰). Other sequences may require other numbers of shifts. For example, b1000 requires no shifts because a “1” is already present at the MSB, while b0001 requires three shifts because the only “1” is present at the least significant bit (LSB), which is the furthest possible spot from the MSB. As another example, the sequence b0000 requires no normalization as it contains no “1”s. Note that the division circuit 100 may be preprogrammed to treat certain cases, such as when the dividend is zero, according to special rules that require no or little calculation.

In some examples, the first normalizer 102 may extend the length of the dividend by an arbitrary number of bits. In some cases, extending the dividend to be longer will provide additional bits that can be used for underflow and/or other purposes. In other cases, extending the number of bits may allow for high accuracy or precision in the calculation of the division later on.

To make the extension of a given dividend more concrete, consider again the example of b0110. The first normalizer 102 may extend this value by an arbitrary number of bits, so suppose the first normalizer 102 wishes to extend b0110 by three bits and then normalize the resulting value. In the first step, extending the sequence, the first normalizer 102 may add three bits (in this case zeroes) to the beginning or end of the sequence (or between any two bits such that the number of bits between all the bits having a value of “1” does not change), thus producing either b0110000 or b0000110. Then, to normalize the sequence, the first normalizer 102 will shift the bits in the higher power direction, ultimately producing b1100000 regardless of where the additional bits were appended. However, the number of shifts (and thus the value of EXP (A)) is different depending on the method used to append the bits. If the additional zeroes were appended to the end of b0110, then only one shift is required to move b0110000 to b1100000. If the zeroes were appended to the beginning of b0110 then four shifts are required to change b0000110 to b1100000. It does not matter which method is used to extend the length of the dividend provided the same method is used by the second normalizer 104 as well (e.g., both normalizers may either both append the zeroes to the end or both append the zeroes to the beginning, but one cannot append the zeroes to the beginning while the other appends the zeroes to the end). Furthermore, if the zeroes are appended to the beginning, a certain number of extra shifts may be incurred compared to if the zeroes are appended to the end. In such case, the value of EXP (A) may be reduced by the number of extra shifts incurred.

The second normalizer 104 operates in the same way as the first normalizer 102. The primary difference is that the second normalizer 104 receives a divisor (“B”) at its input, instead of a dividend, and provides EXP (B) to the second summing node 110, but not also to the first summing node 106. However, the normalization process of B and the determination of EXP (B) are carried out in the same way as the normalization process of A and the determination of EXP (A). For example, if B is b0011, normalization would shift B twice to b1100 and thus EXP (B) would be two (possibly modified by the value of the floating point exponent if B was a floating point value). The divisor may also be extended in the same way as the dividend. For example, if B is b0011 and three bits are to be added to B, then b0011000 or b0000011 could be produced and normalized.

The first summing node 106 is a node where EXP (A) and Length (A) are summed together. Length (A) is the length of A, in bits, prior to any extension or normalization. Thus, if A is b0110 when it is input into the first normalizer 102, Length (A) is equal to four. Likewise, if A is b01100110, Length (A) is equal to eight, and so forth. The first summing node 106 subtracts the value of EXP (A) from Length (A). That is, the summing node may evaluate the expression:

$$Iteration = Length ( A ) - EXP ( A ) \qquad ( 1 )$$

“Iterations” is the number of successive subtractions the subtraction block 108 will be instructed to perform to complete the division calculation prior to de-normalization. The number of iterations may be provided to the subtraction block 108 as a control number (for example, to be compared to a counter as subtractions are performed and completed). Iterations may equal a number of clock cycles, in some example, but is not necessarily equal to the number of clock cycles the division will take. In some examples, to determine the number of clock cycles the division will take, iterations will need to be multiplied by another value, such as an integer.

The subtraction block 108 performs successive subtractions of the normalized value of B (norm (B)) from the normalized value of A (norm (A)). The total number of subtractions performed may be equal to the number of iterations calculated by the first summing node 106 (that is, Length (A)−EXP (A)). Various successive subtraction algorithms exist, including—for example—the binary version of the long division algorithm.

The second summing node 110 takes a sum based on EXP (A) and EXP (B) and provides that sum to the de-normalizer 112. The second summing node 110 may calculate the sum of EXP (A) and EXP (B) as:

$$Sum = MAX ( EXP ( A ) ) + ( EXP ( A ) - EXP ( B ) ) \qquad ( 2 )$$

Where MAX (EXP (A)) represents the bit width for A. For example, if A is a 5 bits long word, the maximum exponent would be 5. The sum of EXP (A) minus EXP (B) represents the number of shifts in the direction of the LSB that may be applied to the output of the subtraction block 108 to account for and reverse the affects of normalizing A and B using the first normalizer 102 and second normalizer 104.

The de-normalizer 112 receives the output of the subtraction block 108 and shifts the output in the direction of the LSB a number of times equal to the sum provided from the second summing node 110, e.g., EXP (A) minus EXP (B). The de-normalizer 112 may then provide the denormalized output to another circuit, circuit element, and/or device, and so forth. The output of the de-normalizer 112 represents the outcome of A=B.

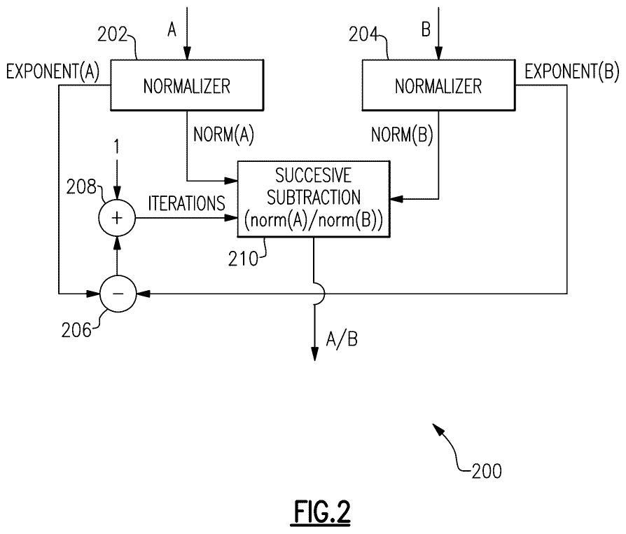

FIG. 2 illustrates a division circuit 200 according to an example. No de-normalization may be necessary when using the division circuit 200. The division circuit 200 includes a first normalizer 202, a second normalizer 204, a first summing node 206, a second summing node 208, and a subtraction block 210.

The first normalizer 202 is coupled to the first summing node 206 at a first connection and to the subtraction block 210 at a second connection. The second normalizer 204 is coupled to the first summing node 206 at a first connection and to the subtraction block at a second connection. The first summing node 206 is coupled to the first normalizer 202 at a first connection, the second normalizer 204 at a second connection, and the second summing node 208 at a third connection. The second summing node 208 is coupled to the first summing node 206 at a first connection and the subtraction block 210 at a second connection. The subtraction block 210 is coupled to the first normalizer 202 at a first connection, the second normalizer 204 at a second connection, and the second summing node 208 at a third connection.

The first normalizer 202 works in a similar manner to the first normalizer 102 of the division circuit 100 of FIG. 1. The first normalizer 202 is configured to receive a dividend (“A”) via an input, normalizes the dividend, and determines the number of shifts (EXP (A)) needed to normalize the dividend.

The second normalizer 204 works in a similar manner to the second normalizer 104 of the division circuit 100 of FIG. 1. The second normalizer 204 is configured to receive a divisor (“B”) via an input, normalizes the divisor, and determines the number of shifts (EXP (B)) needed to normalize the divisor.

Both the first normalizer 202 and second normalizer 204 may extend the number of bits of their respective inputs. Both the first normalizer 202 and second normalizer 204 provide the normalized value they produce to the subtraction block 210, and the number of shifts (e.g., EXP (A) or EXP (B)) to the first summing node 206.

The first summing node 206 takes the sum of EXP (A) and EXP (B), which may be calculated as EXP (A) minus EXP (B), and provides the sum to the second summing node 208. The second summing node 208 takes the sum produced by the first summing node 206 and increases it by one to produce an adjusted sum. The second summing node 208 then provides the adjusted sum to the subtraction block 210.

The subtraction block 210 performs a series of successive subtractions based on the normalized values of A and B (norm (A) and norm (B)). The subtraction block 210 may perform the subtractions in a similar way to the subtraction block 108 of the division circuit 100 of FIG. 1 (e.g., using a successive subtraction algorithm, such as the long division algorithm), or in a different way. For example, whereas the subtraction block 108 of FIG. 1 ordinarily places the result from the MSB down, the subtraction block 210 of FIG. 2 may use a subtraction algorithm that places the result from the LSB up and then performs a left shift (e.g., a shift toward a higher power) every iteration of the subtraction. This results in an implicit denormalization of the result. In some examples, the preferred method of performing a subtraction in the division circuit 200 using the subtraction block 210 is to use the LSB method with the left shift. The number of successive subtractions is based on the adjusted sum received from the second summing node 208. The output of the subtraction block 210 may be the result of A=B.

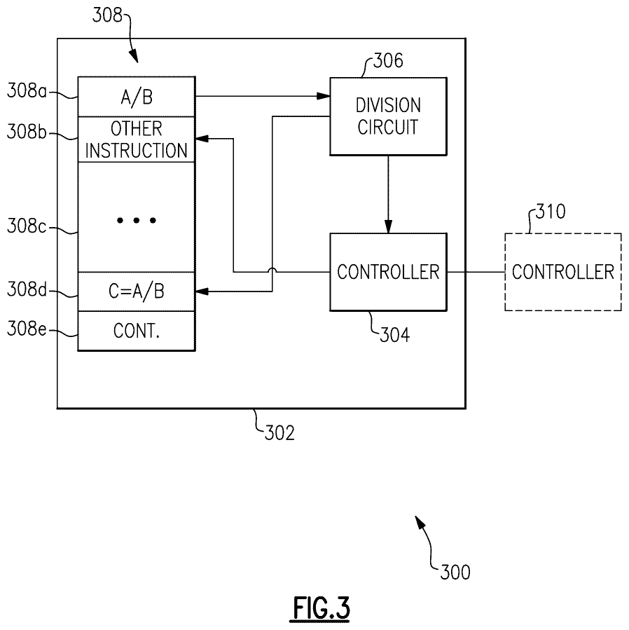

FIG. 3 illustrates a diagram of a circuit architecture 300 (“circuit 300”) according to an example. Circuit 300 includes a core 302, a controller 304, a division circuit 306, an instruction sequence 308 (“stack 308”), and an optional second controller 310. The stack 308 includes a plurality of instructions including a first instruction 308a, a second instruction 308b, an optional sequence of one or more third instructions 308c (“third instructions 308c”), a fourth instruction 308d, and a fifth instruction 308c.

The division circuit 306 is configured to receive instructions related to division. For example, from the stack 308, the division circuit 306 may receive an instruction instructing it to perform a division operation such as A=B. In FIG. 3, the first instruction 308a is an instruction to perform the operation A=B. Once the division circuit 306 receives this instruction, the division circuit 306 determines the amount of time (e.g., the number of clock cycles) that it will take to perform A=B. The division circuit 306 provides the amount of time it will take to perform A=B to the controller 304. The division circuit 306 may carry out A=B over the period of time that it determined A=B would take. In some examples, the amount of time is a minimum amount of time, but the actual time the division will take will be greater than the minimum amount of time, but in each case, the amount of time is determined (i.e., known in advance of the actual division). The controller 304, in receipt of the amount of time it will take to perform A=B, may now place an instruction on the stack 308. For example, while the controller 304 could place a wait or idle instruction on the stack 308, the controller 304 may also utilize the available resources of the core 302 to perform other operations. In FIG. 3, the controller 304 provides a second instruction 308b that is not a wait or idle instruction. The controller 304 may also provide the third instructions 308c that may include wait or idle instructions, but may also not include wait or idle instructions. The total number of instructions encompassed by the second instruction 308b and the third instructions 308c may take an amount of time to execute that is equal to or less than the amount of time it will take division circuit 306 to perform A=B.

Once the division circuit 306 completes the computation of A=B, the division circuit 306 and/or controller 304 may place an instruction related to A=B onto the stack 308. In FIG. 3, fourth instruction 308d is related to A=B. For example, the fourth instruction 308d may be an instruction related to a thread or process that required the division result, e.g., Let C=A/B. Alternatively, the fourth instruction 308d may correspond to the time that A/B becomes available to place in C (e.g., to place in a register or other location for use). That is, instruction 308d may immediately follow, immediately proceed, or occur concurrently with A/B becoming available to place in C.

The fifth instruction 308e may be one or more instructions related to the division or not, and may represent the continuation of operations by the core 302.

The second controller 310 is optional, and may represent another core 302, processor, or other device, and may be running other threads or processes. The second controller 310 may interface with the controller 304 so that the second controller 310 can provide instructions to the stack 308 and use the resources of the core 302 while the core 302 is waiting for the division circuit 306 to complete computation of A=B.

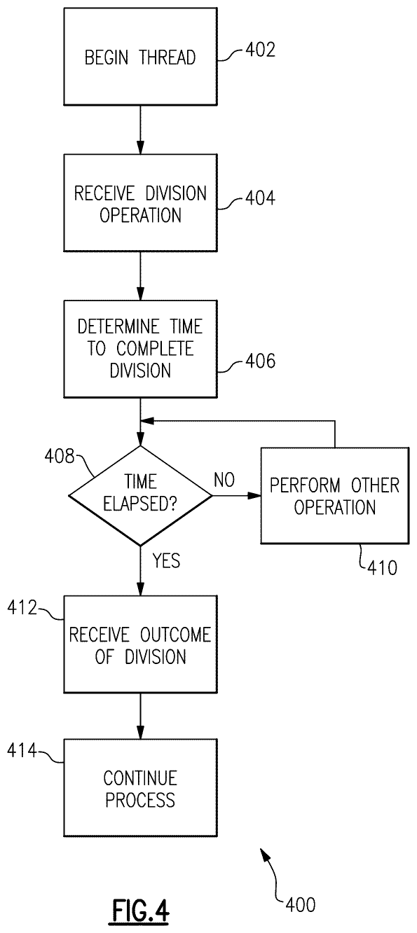

FIG. 4 illustrates a process 400 for utilizing resources during a division operation according to an example.

At act 402, a controller or other circuit begins a thread (such as executing an application, process, and so forth). The thread may be any process or task that can be performed on a computer. The process 400 then continues to act 404.

At act 404, the controller, as part of the thread, receives a division operation. For example, the controller may receive an instruction corresponding to performing a division. The controller may determine that a deterministic division circuit (such as those described herein) is appropriate for performing the division, and may instruct the deterministic division circuit to perform the division. The process 400 may then continue to act 406.

At act 406, the division circuit or the controller may determine the amount of time it will take to complete the division. The amount of time may, in some examples, be measured in clock cycles. The amount of time may be based on a difference between the number of shifts used to normalize the dividend and divisor of the division operation. The process 400 may then continue to act 408.

At act 408, the controller checks whether the amount of time the division operation was determined to take has elapsed. If the controller determines the amount of time has not elapsed (408 NO), the process 400 may continue to act 410. If the controller determines the amount of time has elapsed (408 YES), the process 400 may continue to act 412.

At act 410, the controller may use the resources available to it to perform other operations while the division is carried out by the division circuit. For example, the controller may use a multiplication circuit to carry out a multiplication unrelated to the division, and so forth. In general, the controller may use the resources available to it to carry out any operation or operations or may make the resources available to it also available to other controllers for use.

In the foregoing, subtraction may be performed using the one's complement or two's complement, or other encoding of a binary number into a “negative” representation. In some examples, two's complement may be used as two's complement may simplify subtraction into an addition operation when performed using some digital logic circuits.

In the foregoing, various special cases may arise. For example, given a dividend and divisor A/B, either A or B may be zero. When B is zero, the operation is undefined. When A is zero, the operation results in zero. When A/B are both zero (e.g., 0/0) the operation may be undefined. When these cases occur, no calculation or computation may be necessary, and the division circuit (e.g., division circuit 100, 200) may simply return zero or raise a flag indicating the operation is undefined, as appropriate for the given case.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 304, may execute various operations discussed above. Using data stored in associated memory and/or storage, the controller 304 also executes one or more instructions stored on one or more non-transitory computer-readable media, which the controller 304 may include and/or be coupled to, that may result in manipulated data. In some examples, the controller 304 may include one or more processors or other types of controllers. In one example, the controller 304 is or includes at least one processor. In another example, the controller 304 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A division circuit comprising:
a first normalizer configured to shift a first input to a first higher power;
a second normalizer configured to shift a second input to a second higher power;
a subtraction circuit configured to iteratively subtract the second input from the first input for a number of iterations to produce a result, the number of iterations based on a number of shifts of the first input;
a first output configured to provide the result; and
a second output configured to provide the number of iterations.

2. The division circuit of claim 1 further comprising a first summing node, and a second summing node, the first summing node coupled between the first normalizer and the subtraction circuit and the second summing node coupled between the first normalizer and the second normalizer.

3. The division circuit of claim 2 wherein the first summing node is configured to provide to the subtraction circuit a difference based on a width of the first input and the number of shifts of the first input.

4. The division circuit of claim 2 further comprising a denormalizer.

5. The division circuit of claim 4 wherein the second summing node is configured to provide a difference of the number of shifts of the first input and a number of shifts of the second input to the denormalizer.

6. The division circuit of claim 5 wherein the denormalizer is configured to shift the result to a lower power, a number of shifts of the result to the lower power based on the difference of the number of shifts of the first input and the number of shifts of the second input.

7. The division circuit of claim 1 further comprising a first summing node coupled between the first normalizer, the second normalizer, and a second summing node, the second summing node being further coupled to the subtraction circuit.

8. The division circuit of claim 7 wherein the first summing node is configured to determine a difference based on the number of shifts of the first input and a number of shifts of the second input, and to provide the difference to the second summing node.

9. The division circuit of claim 8 wherein the second summing node is configured to determine a sum of the difference and a constant value, and to provide the sum to the subtraction circuit.

10. The division circuit of claim 9 wherein the number iterations is based on the sum.

11. A computer system comprising:
a division circuit; and
at least one controller, the at least one controller configured to:
provide an instruction to the division circuit to perform a division;
receive, from the division circuit, a number of iterations corresponding to a number of clock cycles that the division will take to perform;
execute one or more operations for the number of clock cycles while the division is being performed by the division circuit; and
receive a result of the division.

12. The computer system of claim 11 wherein the division circuit includes:
a first normalizer configured to shift a first input to a first higher power;
a second normalizer configured to shift a second input to a second higher power;
a subtraction circuit configured to iteratively subtract the second input from the first input for a number of iterations to produce a result, the number of iterations based on a number of shifts of the first input;
a first output configured to provide the result; and
a second output configured to provide the number of iterations to at least the controller.

13. The computer system of claim 12 wherein the division circuit includes:
a denormalizer configured to shift the result to a lower power based on a difference between the number of shifts of the first input and a number of shifts of the second input.

14. The computer system of claim 12 wherein the number of iterations is further determined based on a difference between a width of the first input and the number of shifts of the first input, wherein the number of shifts of the first input equals the number of shifts of the first input by the first normalizer to the first higher power.

15. The computer system of claim 12 wherein the number of iterations is further determined based on a difference of the number of shifts of the first input and a number of shifts of the second input.

16. The computer system of claim 11 further comprising at least one additional controller, the at least one additional controller being configured to receive instructions from the controller and to execute those instructions for the number of clock cycles.

17. The computer system of claim 16 wherein the one or more operations are unrelated to the division.

18. A method for efficiently utilizing computational resources, the method comprising sequentially performing operations following a beginning of a division operation using computational resources other than the division circuit for a number of clock cycles equal to or greater than a minimum number of clock cycles, wherein the minimum number of clock cycles is determined by shifting a first input to a first higher power by a first number of shifts and modifying the first number of shifts by a second value to produce a number of iterations corresponding to the minimum number of clock cycles.

19. The method of claim 18 wherein the second value is a width of the first input, and the number of iterations is determined based on a difference between the first number of shifts and the second value.

20. The method of claim 18 wherein the second value is a second number of shifts, the second number of shifts being a number of shifts of a second input, and the number of iterations is determined based on a difference between the first number of shifts and a second number of shifts.
